(19) United States
(12) Patent Application Publication
(10) Pub. No.: US 2025/0296138 A1
(43) Pub. Date: Sep. 25, 2025

(54) METHOD OF DETERMINING A WALL THICKNESS REDUCTION, %WR OF PIPES FIXED IN PIPE SHEET HOLES, SYSTEM THEREFORE AND USE OF THE METHOD

(71) Applicant: VESTAS AIRCOIL A/S, Lem St. (DK)

(72) Inventors: Frank NIELSEN, Lem (DK); Claus IBSEN, Lem (DK)

(21) Appl. No.: 18/864,532

(22) PCT Filed: May 10, 2023
(86) PCT No.: PCT/DK2023/050114

§ 371 Date: Nov. 10, 2024

(30) Foreign Application Priority Data
May 12, 2022 (DK) PA 2022 70254

(51) Int. Cl. B21D 39/20; G01B 11/06

(52) U.S. Cl. CPC B21D 39/20; G01B 11/06

(57) ABSTRACT

A method of determining a wall thickness reduction, % WR of a pipe fixed in a pipe sheet hole in a pipe sheet by expansion is provided. The method includes an act of receiving initial inner diameter of pipe before expansion, outer diameter of pipe before expansion, inner diameter of pipe sheet hole and final inner diameter of the pipe after expansion, and an act of determining the wall thickness reduction, % WR of the pipe based on the received diameters. An imaging system for performing the method and a use of the method is also provided.

### CROSS-REFERENCE TO RELATED APPLICATIONS

This application is a national stage of PCT Application No. PCT/DK2023/050114, having a filing date of May 10, 2023, which is based on DK Application No. PA 2022 70254, having a filing date of May 12, 2022, the entire contents both of which are hereby incorporated by reference.

### FIELD OF TECHNOLOGY

The following relates to a method of determining a wall thickness reduction, % WR of a pipe fixed in a pipe sheet hole in a pipe sheet by expansion.

In embodiments, the method comprises an act of receiving initial inner diameter of pipe before expansion, outer diameter of pipe before expansion, inner diameter of pipe sheet hole and final inner diameter of the pipe after expansion, and an act of determining the wall thickness reduction, % WR of the pipe based on the received diameters.

The following furthermore relates to an imaging system for performing the method and a use of the method.

### BACKGROUND

It is known to mount and fix pipes in pipe sheets by expansion of the pipes after positioning the pipes in holes in the pipe sheet. This technique is applied during the production of a wide range of devices for obtaining sufficient tightness between a pipe penetrating a plate, particularly in applications where it is desirable to have for example a liquid on one side of the plate and air or other liquid/media on the other side of the plate. Leaking in the connection between the pipe and the plate is undesirable.

Techniques for assembling such parts by expansion of the pipes are used in particular in heat exchangers and steam generators employed in the oil industry, the chemical industry, the production of gas, energy, in the metallurgical industry and in the construction of ships, including marine atomic energy installations, nuclear power plants and related industries.

Commonly used expansion processes include a mandrel i.e. a tool with rollers acting on the pipes from within and controlling the expansion of the pipes through a predetermined parameter of the motor torque transmitted to the mandrel. The parts included in this process includes various variations such as pipe wall thickness, diameter of the pipes and of the holes in the pipe sheets, and individual characteristics of each mandrel assembly including general wear of the mandrel.

JPS55161532 A discloses an automatic tube expanding device with a tube expander unit, a thrust moving device for moving the unit and a control device for controlling the operation of the unit and thrust moving device, wherein a wall thickness reduction during the tube expansion is based on the tube expansion torque.

The assembly is typically leak-tested afterwards testing each pipe assembly individually.

However, this leakage-test does not test the quality of the pipe after expansion. For obtaining a good quality of the device with the pipes fixed in the pipe sheet, the pipes must undergo a plastic deformation during the expansion while the plate sheets should only be exposed to an elastic deformation, thereby regaining the original hole size after the expansion process while the pipes should maintain the deformation after the expansion process. Furthermore, the plastic deformation of the pipes must be kept below the critical point of breakage.

Furthermore, it is very cumbersome and impractical to test and repair such connections.

Therefore, a method of verifying the assembly of the pipes in the pipe holes is disclosed to verify the quality of the assembly.

### SUMMARY

An aspect relates to a method of determining a wall thickness reduction, % WR of a pipe fixed in a pipe sheet hole in a pipe sheet by expansion.

An aspect relates to a method which is easy to use, easy to apply, and may be applied in a very quick and safe manner for quality control of the assembled pipes penetrating the pipe sheets. An aspect relates to achieve a system for implementing the method.

Embodiments of the invention address these objectives by providing a method of determining a wall thickness reduction, % WR of a pipe fixed in a pipe sheet hole in a pipe sheet by expansion.

In embodiments, the method comprises an act of receiving:
an initial inner diameter of pipe before expansion, d_i,
an outer diameter of pipe before expansion, d_o,
an inner diameter of pipe sheet hole, D_i, and
a final inner diameter of the pipe after expansion, d_ia.

In embodiments, the method furthermore includes an act of determining the wall thickness reduction, % WR of the pipe based on the received diameters d_i, d_o, D_i and d_ia.

Particularly, for heat exchangers or large cooling installations a large number of pipes fixed as through-going pipes in end plates are necessary in order to provide sufficient heat exchange areas in a heat exchanger. In these constructions, the pipes will typically be very close to each other and as such, there is not much space to operate on.

The leakage-tests typically applied after the assembly only indicate whether the seal is tight or not. However, the quality of the seal and the pipe after assembly is not indicated by these tests.

By determining a wall reduction, % WR of the pipes after assembly the quality of the device with the pipes fixed in the pipe sheet can be controlled. In this type of devices, the seal is achieved by exposing the pipes to a plastic deformation during the expansion while the plate sheets should only be exposed to an elastic deformation, thereby regaining the original hole size after the expansion process, while the pipes maintain the deformation after the expansion process. Furthermore, the plastic deformation of the pipes must be kept below the critical point of breakage, to maintain the durability of the pipes according to the intended use i.e. exposure to pressure.

Due to the wall thickness reduction caused by the expansion of the pipe, the pipe material will extend along a longitudinal axis of the pipe.

Using only the final inner diameter of the pipe, d_ia as the only parameter of the assembled part after expansion of the pipe, a reliable method for determining the wall thickness reduction is achieved. Expansion of the pipe to the extend where a plastic deformation of the pipe is achieved while only an elastic deformation of the sheet plate is reached results in yield of the pipe material to extend beyond the sheet hole, i.e. after expansion, pipe material may bulge over the edge of the pipe sheet hole and thus covers the edge of the sheet hole, thereby preventing determining or measuring the inner diameter of the pipe sheet hole and the outer diameter of the pipe after expansion.

In an embodiment of the method, the wall thickness reduction, % WR of the pipe after expansion is determined by:

$$\% WR = 100 \cdot \frac{1 / 2 ( {d}_{i a} - {d}_{i} ) - 1 / 2 ( {D}_{i} - {d}_{o} )}{1 / 2 ( {d}_{o} - {d}_{i} )} .$$

This can also be expressed as

$$\% WR = \frac{Δ R - c}{t} ,$$

where:
ΔR is the change in inside radius of the pipe before and after expansion,
c is the clearance between the pipe and pipe sheet before expansion, and
t is the pipe thickness before expansion.

In an embodiment of the method, the received diameters d_i, d_o, D_i and d_ia are estimated based on detection of multiple points connected to the initial inner diameter of pipe before expansion d_i and/or the outer diameter of pipe before expansion d_o, the inner diameter of pipe sheet hole D_i, and the final inner diameter of the pipe after expansion d_ia, respectively.

The diameters may be estimated by a suitable form of triangulation, curve-fitting or other mathematical modelling based on recognizable features associated with one or more of the pipes diameters and the pipe sheet hole diameter.

The estimates may be achieved by applying computer modelling, machine learning or other computer implemented calculations or estimates.

The machine learning may be implemented by use of SVM, KNN, rCNN or similar methods.

Extreme care must however be taken for obtaining reliable estimates of the diameters.

In an embodiment, the method includes using an imaging device arranged externally to the pipe sheet with an optical axis of the imaging device being aligned approximately parallel to a longitudinal axis of the pipe sheet hole(s), wherein embodiments of the method comprises an act of capturing a first image of the pipe sheet with the pipe(s) inserted in the pipe sheet hole(s) before expansion, and from the first image determining:
the initial inner diameter of pipe before expansion, d_i,
the outer diameter of pipe before expansion, d_o, and
the inner diameter of pipe sheet hole, D_i, and a further act of capturing a second image of the pipe sheet with the pipe(s) inserted in the pipe sheet hole(s) after expansion, and from the second image determining the final inner diameter of the pipe after expansion, d_ia.

One effect of using an imaging device external to the sheet and hence the pipes may be beneficial in obtaining an efficient method where only a single image is required for determining the wall thickness reduction % WR of multiple pipes. This may lead to an fast verification of the assembled parts.

In addition, the captured images may be stored and saved for later quality verification.

In an embodiment of the method, the diameters d_i, d_o, D_i and d_ia may be determined using image analysis.

In a further aspect of embodiments of the method which includes using an imaging device, the image device is an optical imaging device, and the captured images are optical images.

An aspect relates to a system for determining the wall thickness reduction % WR of the pipe fixed in the pipe sheet hole by expansion.

In embodiments, the system may comprise an imaging device configured to be arranged externally to the pipe sheet with an optical axis of the imaging device being aligned approximately parallel to a longitudinal axis of the pipe and configured for capturing images.

In embodiments, the system may furthermore comprise a processor configured for receiving the captured images and for performing image analysis on the captured images for determining a diameter of an item comprised in the captured image and means adapted to execute the acts of the disclosed method according to the embodiments for determining the wall thickness reduction, % WR.

The effect and benefits achieved with such a system are in line with those already described in connection with the embodiments of the method. Hence, embodiments of the system supports implementing and effecting the method of determining the wall thickness reduction, % WR.

An aspect relates to a method achieved by a computer program product (non-transitory computer readable storage medium) comprising instructions, which, when the program is executed by a computer, cause the computer to carry out one or more method acts of the method of determining the wall thickness reduction, % WR.

The embodiment may have the effects and advantages in line with those previously described in connection with the method of determining the wall thickness reduction, % WR and the system, therefore.

An aspect relates to a method achieved by computer-readable media comprising instructions which, when executed by a computer, cause the computer to carry out one or more method acts of the method of determining the wall thickness reduction, % WR.

The instructions to be carried out may be comprised in or output from the algorithms, in a computer program product comprising one or more method acts of the method of determining the wall thickness reduction, % WR.

The embodiment further supports the effects and advantages of the method and system as described above.

An aspect relates to a method achieved by use of the method according to the embodiments for determining the wall thickness reduction, % WR for diagnosing pipes fixed in pipe sheet holes by expansion, wherein the wall reduction is in the range of 2% to 15% in the range of 4% to 10% and/or in the range of 4% to 6%.

The optimal wall thickness reduction depends on the specific material of the pipe. Typical materials may be stainless steel or copper. However, the pipe may be made of other materials chosen in view of the specific application of the device comprising the fixed pipe sheet.

In a further aspect, the use of embodiments of the method is where the expansion of the pipes fixed in the pipe sheet holes is of the type achieved from causing a tool with rollers to act on a pipe and controlling the expansion process according to a parameter of the expansion force transmitted to the tool.

### BRIEF DESCRIPTION

Some of the embodiments will be described in detail, with references to the following Figures, wherein like designations denote like members, wherein:

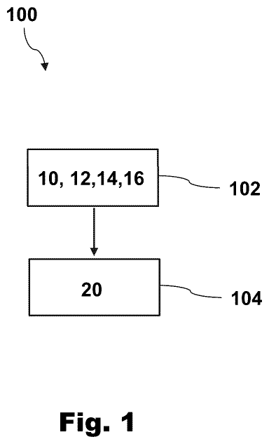

FIG. 1 illustrates an embodiment of the method;

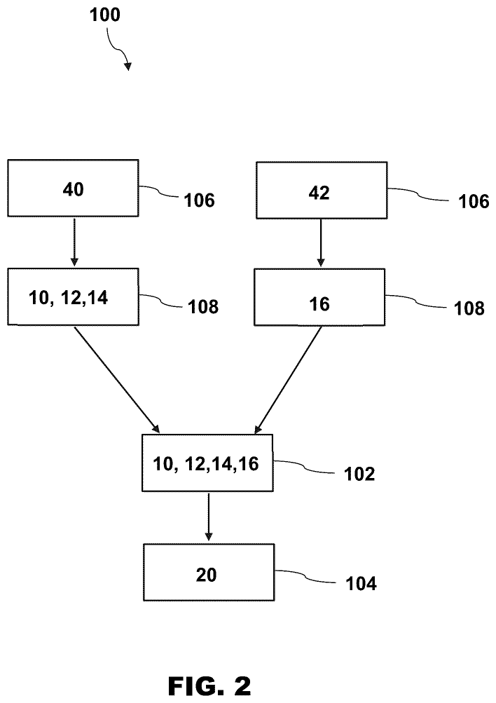

FIG. 2 illustrates an embodiment of the method;

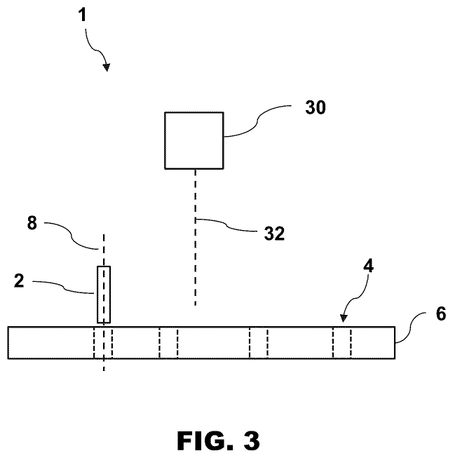

FIG. 3 illustrates an embodiment of the system;

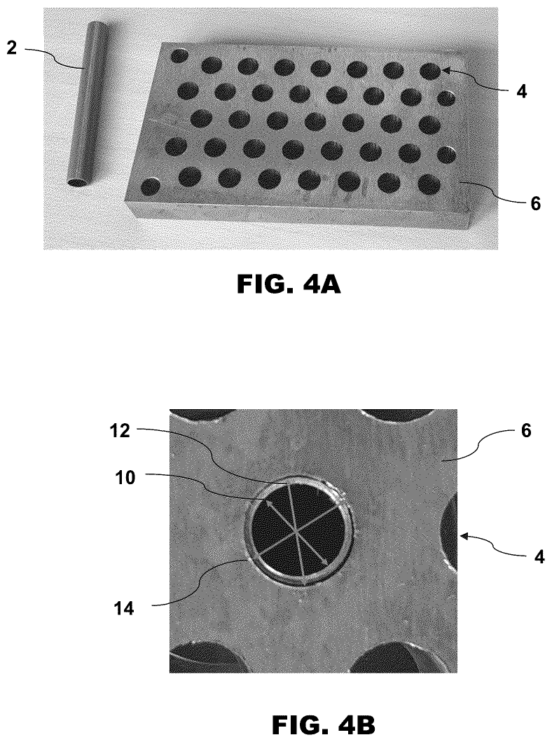

FIG. 4A illustrates an embodiment of a pipe sheet and a pipe;

FIG. 4B illustrates an embodiment of a pipe inserted in the one of the pipe sheet holes;

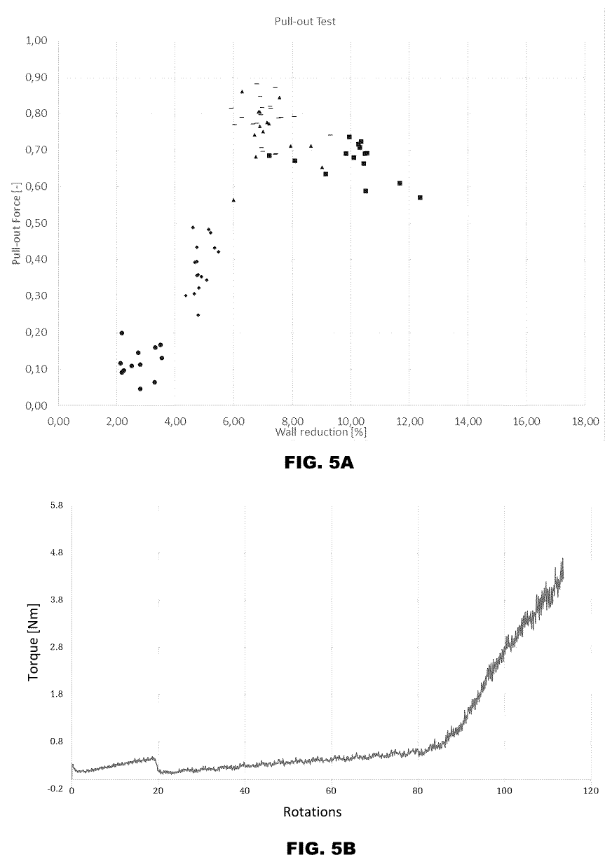

FIG. 5A illustrates tests performed on pipes arranged in pipe sheet holes expanded by rolling; and

FIG. 5B illustrates the torque [Nm] vs rotations of an expansion process by rolling.

### LIST OF REFERENCE NUMBERS

No Item
1 System
2 pipe
4 pipe sheet hole
6 pipe sheet
8 longitudinal axis, pipe
10 initial inner diameter of pipe before expansion, d_i
12 outer diameter of pipe before expansion, d_o
14 inner diameter of pipe sheet hole, D_i
16 final inner diameter of the pipe after expansion, d_ia
18 points
20 wall thickness reduction, % WR
30 imaging device
32 optical axis
40 first image
42 second image
100 method
102 receiving
104 determining
106 capturing
108 determining

### DETAILED DESCRIPTION

FIG. 1 illustrates an embodiment of a method 100 of determining a wall thickness reduction, % WR of a pipe fixed in a pipe sheet hole by expansion.

The illustrated embodiment of the method comprises an act of receiving 102 an initial inner diameter of pipe before expansion, d_i (10), an outer diameter of pipe before expansion, d_o 12, an inner diameter of pipe sheet hole, D_i 14, and a final inner diameter of the pipe after expansion, d_ia 16. In embodiments, the method also includes an act of determining 104 the wall thickness reduction, % WR of the pipe based on the received diameters 10,12,14,16.

FIG. 2 illustrates an embodiment of the method 100 of determining a wall thickness reduction, % WR as illustrated in FIG. 1. In an embodiment, the method includes capturing 106 a first image 40 and a second image 42 of the pipe sheet with the pipe(s) inserted in the pipe sheet hole(s) before and after expansion of the pipe respectively.

From the first image 40, the diameters d_i (10), d_o (12), and D_i (14) are determined 108. From the second image 42, the diameter, d_ia (16) is determined 108.

FIG. 3 illustrates an embodiment of the system 1 comprising an imaging device 30 arranged externally to the pipe sheet 6 with an optical axis 32 of the imaging device 30 being aligned approximately parallel to a longitudinal axis 8 of the pipe sheet hole(s) 4.

In an embodiment a pipe 2 is illustrated to be inserted into one of the pipe sheet holes 4.

FIGS. 4A and 4B illustrate an embodiment of a pipe sheet 6 with pipe sheet holes 4 and a pipe 2 adapted to be inserted in the one of the pipe sheet holes 4. In FIG. 4A, the pipe 2 embodiment is illustrated before insertion of the pipe 2 into the hole 4. FIG. 4B illustrates the embodiment with the pipe 2 inserted into the hole 4 and with the diameters d_i (10), d_o (12) and D_i (14) indicated.

FIG. 5A illustrates measured wall thickness reductions (%) versus measured maximum torque of the expansion tool used for expanding the pipe. The maximum torque is measured right before terminating the expansion process. The wall thickness reduction measurements are performed for expansion of pipes by rolling with rolling depth of 15 mm and 21 mm respectfully.

FIG. 5B illustrates the torque [Nm] vs rotations of an expansion process by rolling. The part of the cure beyond ˜85 illustrates the process where the pipe is being plastic deformed and the pipe sheet elastic deformed and thus the area of operation for fixing pipes in pipe sheet holes.

From FIG. 5A the point where also the pipe sheet is being plastic deformed can be deducted. When the deformation changes from elastic to plastic, the torque needed to further expand the pipe sheet hole is reduced, which for the performed test samples occurs somewhere between 7 to 10% WR. The test sample pips are made of CuNi10 with Ø13 mm.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method of determining a wall thickness reduction, % WR of a pipe fixed in a pipe sheet hole in a pipe sheet by expansion, the method comprises acts of:
using an imaging device arranged externally to the pipe sheet for capturing a first image and a second image with an optical axis of the imaging device being aligned approximately parallel to a longitudinal axis of the pipe sheet hole,
capturing a first image of the pipe sheet with the pipe(s) inserted in the pipe sheet hole(s) before expansion and from the first image
determining:
the initial inner diameter of pipe before expansion, d_i,
the outer diameter of pipe before expansion, d_o, and
the inner diameter of pipe sheet hole, D_i:
capturing a second image of the pipe sheet with the pipe(s) inserted in the pipe sheet hole(s) after expansion and form the second image
determining the final inner diameter of the pipe after expansion d_ia
receiving:
an initial inner diameter of pipe before expansion, d_i,
an outer diameter of pipe before expansion, d_o,
an inner diameter of pipe sheet hole, D_i, and
a final inner diameter of the pipe after expansion, d_ia, and
determining the wall thickness reduction, % WR of the pipe based on the received diameters.

2. The method according to claim 1, wherein the wall thickness reduction % WR of the pipe after expansion is determined by:
$$\% WR = 100 \cdot \frac{1 / 2 ( {d}_{i a} - {d}_{i} ) - 1 / 2 ( {D}_{i} - {d}_{o} )}{1 / 2 ( {d}_{o} - {d}_{i} )} .$$

3. The method according to claim 1, wherein the received diameters are estimated based on detection of multiple points connected to the initial inner diameter of pipe before expansion and/or the outer diameter of pipe before expansion, the inner diameter of pipe sheet hole, and the final inner diameter of the pipe after expansion, respectively.

4. The method according to claim 1, wherein the diameters are determined using image analysis.

5. The method according to claim 1, wherein the image device is an optical imaging device, and the captured images are optical images.

6. A system for determining a wall thickness reduction, % WR of a pipe fixed in a pipe sheet hole by expansion, the system comprising:
an imaging device configured to be arranged externally to the pipe sheet with an optical axis of the imaging device being aligned approximately parallel to a longitudinal axis of the pipe, and configured for capturing images,
a processor configured for receiving the captured images, and for performing image analysis on the captured images for determining a diameter of an item comprised in the captured image, and for determining the wall thickness reduction, % WR of the pipe based on the diameters, the system being configured
to execute the acts of the method of claim 1, for determining the wall thickness reduction, % WR.

7. A computer program product, comprising a computer readable hardware storage device having computer readable program code stored therein, and program code executable by a processor of a computer system to implement a method comprising instructions, which, when the program is executed by a computer, cause the computer to carry out one or more method acts of the claim 1.

8. The computer readable media comprising instructions which, when executed by a computer, cause the computer to carry out one or more method acts of the method of claim 1.

9. A method comprising using the method according to claim 1, for diagnosing pipes fixed in pipe sheet holes by expansion wherein the wall reduction % WR is in the range of 2% to 15%.

10. A method comprising using the method according to claim 9, wherein the expansion of the pipes fixed in the pipe sheet holes is of the type achieved from causing a tool with rollers to act on a pipe and controlling the expansion process according to a parameter of the expansion force transmitted to the tool.

11. The method according to claim 9 for diagnosing pipes fixed in pipe sheet holes by expansion wherein the wall reduction % WR is in the range of 4% to 10%.

12. The method according to claim 11 for diagnosing pipes fixed in pipe sheet holes by expansion wherein the wall reduction % WR is in the range of 4% to 6%.
